(19) United States
(12) Patent Application Publication
(10) Pub. No.: US 2023/0222382 A1
(43) Pub. Date: Jul. 13, 2023

(54) SYSTEMS AND METHODS FOR MACHINE LEARNING MODEL TRAINING AND DEPLOYMENT

(71) Applicant: Tektronix, Inc., Beaverton, OR (US)

(72) Inventors: Wenzheng Sun, Beaverton, OR (US); Xiaolan Wang, Hillsboro, OR (US); Justin E. Patterson, Honolulu, HI (US)

(73) Assignee: Tektronix, Inc., Beaverton, OR (US)

(21) Appl. No.: 18/081,616

(22) Filed: Dec. 14, 2022

Related U.S. Application Data
(60) Provisional application No. 63/297,382, filed on Jan. 7, 2022.

(51) Int. Cl. G06N 20/00

(52) U.S. Cl. CPC G06N 20/00

(57) ABSTRACT

A system to develop and test machine learning models has a waveform emulator machine learning system, a user interface to allow a user to input one or more design parameters for the waveform emulator machine learning system, one or more processors configured to execute code to cause the one or more processors to: send the one or more design parameters to the waveform emulator machine learning system; receive one or more data sets from the waveform emulator machine learning system, the one or more data sets based on the one or more design parameters; train a developed machine learning model using at least one of the one or more data sets, resulting in a trained machine learning model; validate the trained machine learning model using a previously unused one of the one or more data sets; adjust the trained machine learning model as needed; and repeat the training, validating, and adjusting until an optimal machine learning model is trained. A method of developing and testing machine learning models includes providing one or more design parameters to a waveform emulator machine learning system, receiving one or more data sets from the waveform emulator machine learning system, training a developed machine learning model using at least one of the one or more data sets, resulting in a trained machine learning model, validating the trained machine learning model using a previously unused one of the one or more data sets, adjusting the trained machine learning model as needed, and repeating the training, validating, and adjusting until an optimal machine learning model is trained.

### CROSS-REFERENCE TO RELATED APPLICATIONS

This disclosure claims benefit of U.S. Provisional Application No. 63/297,382, titled “SYSTEMS AND METHODS FOR MACHINE LEARNING ALGORITHM TRAINING AND DEPLOYMENT,” filed on Jan. 7, 2022, the disclosure of which is incorporated herein by reference in its entirety.

### TECHNICAL FIELD

This disclosure relates to test and measurement systems, and more particularly to training processes for machine learning models used in test and measurement applications.

### DESCRIPTION

Machine learning (ML) models, algorithms and/or systems, referred to here as “models,” require a large amount of data for training and validation. These models include supervised learning, unsupervised learning, semi-supervised, and reinforcement learning models. The use of labeled training data typically exists in supervised and semi-supervised learning models, in which the model is trained on known data with known results, and then when the model receives new data, the model can identify or predict results, parameters, etc., from the new data based upon its training.

In the context of a test and measurement application, such as testing or measuring aspects of a device under test (DUT), the amount of data required is often unrealistic to acquire from a user. The user may be the manufacturer of the DUT. Data acquired from the user is often not comprehensive enough to train a robust ML model, as the data results from testing and verification of the DUT design, operation, etc. This often results in data having narrow parameter ranges or situations that generate the results, limiting the data in scope, which in turn limits the capabilities of the system trained on that data.

### BRIEF DESCRIPTION OF THE DRAWINGS

FIG. 1 shows an embodiment of a machine learning system.

FIG. 2 shows a flowchart of an embodiment of a machine learning neural network development process.

FIG. 3 shows a flowchart of an embodiment of a machine learning neural network retraining process from existing DUT data.

FIG. 4 shows a flowchart of an embodiment of a machine learning neural network retraining and adjustment process.

### DETAILED DESCRIPTION

The embodiments encompass a general-purpose machine learning process that utilizes a waveform emulator, such as that disclosed in U.S. patent application Ser. No. 17/893,073, “Digital Twin with Machine Learning Waveform Generation Including Parameter Control for Device Under Test Emulation,” filed Aug. 22, 2022. While the below discussion may refer to the emulator as being of the system described in the patent application, other types of waveform emulators that use machine learning to generate data sets of waveforms may also be used.

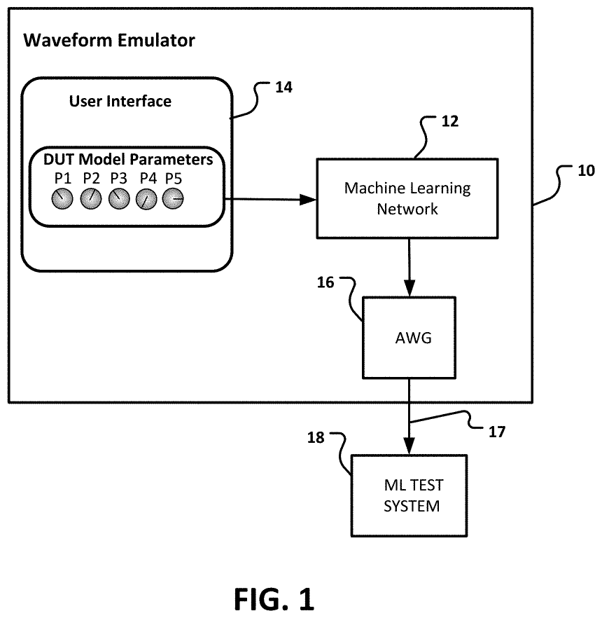

FIG. 1 shows a system block diagram of a waveform emulator 10 including a trained machine learning model. As used here, the term “model” refers to the machine learning algorithm/network/model that processes the data to produce the desired result, such as a prediction. The machine learning model in the waveform emulator 10 can generate simulated waveforms based on user inputs. FIG. 1 shows the waveform emulator in operational mode, where the machine learning (ML) model has already undergone training. The waveform emulator generates a waveform, or waveform signal, that causes an Arbitrary Waveform Generator 16 to generate an analog electrical waveform.

The user interface 14 includes a DUT model parameter panel through which the user can select particular values for the parameters to generate the desired waveform. The DUT model parameter panel may comprise a graphical user interface, or may be controlled through programmatic commands. The particular parameters illustrated represent typical parameters used to train the machine learning (ML) model 12. The training of the ML model 12 will typically train the ML model to associate a particular waveform with a particular set of parameters. In the operational or run-time mode, the user selects parameters using the user interface 14. In the “Digital Twin” embodiments, the ML model 12 would then generate the best waveform, or a signal indicative of the waveform, as its output from the ML model 12. This output results from the exact parameter settings in the DUT model parameter panel of the user interface 14. The output from the ML model 12 then causes the AWG 16 to generate an analog electrical waveform signal.

During training, the ML model 12 “learned” to associate particular waveforms to parameters used to generate the waveform and linked them as metadata. In the run-time mode, the ML model works in reverse. It generates the waveform based on the parameters used to create it. In operation, as the user adjusts the individual parameters in the DUT model parameter panel on the user interface 14, the ML model 12 generates a waveform that most closely matches the selected parameters. The waveform emulator and its ML model may take the form of a software application running on one or more general purpose or special purpose processors, for example.

The embodiments here can use this type of waveform emulator to generate large numbers of waveforms to use as one or more data sets for training and validation of a different ML model 18. Rather than using the emulator to produce one waveform that meets the parameter criteria, the developer would design and sweep waveform parameters, such as voltage levels, noise levels, etc., relevant to the desired measurement outcomes. The system would then use these parameters as inputs to the waveform emulator ML model to generate large numbers of emulated waveforms, usually in the thousands.

The designed parameter sweep should aim to encapsulate as many possible scenarios. For example, a ML model to predict TDECQ (Transmitter Dispersion and Eye Closure Quaternary) values and waveforms could use the emulator to generate one or more data sets having a wide range of TDECQ values. The developer could then go through an iterative process of improving the ML model through a training and validation cycle until they reach a desired ML model. Failures in the validation checks may result in the developer adjusting or reprogramming the ML model. For example, this may cause the developer to alter connections and/or nodes in layers of a neural network to improve the performance of the ML model.

The ML model under development may comprise a computing device having one or more general purpose or specialized processors that the developer can program to embody the ML model under development, referred to here as the “developed ML model.” The developed ML model and the waveform emulator may operate as software on one or more computing devices, including test and measurement instruments. The waveform emulator may reside in a separate or the same computing device. The connection 17 between the waveform emulator 10 and the machine learning test system, meaning the developed machine learning model 18, may take the form of a physical connection between two or more processors or through a port, or may take the form of a connection between the two systems in software. The developed machine learning model may be tailored for a specific test and measurement process, such as TDECQ mentioned above, among many other types of developed machine learning models, including those used to test performance and parameters for many different types of DUTs.

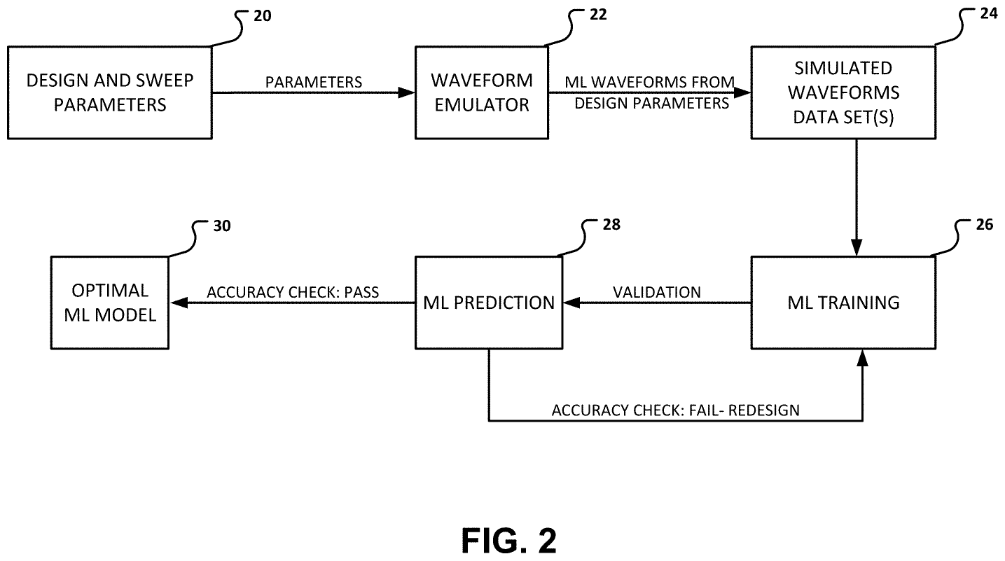

FIG. 2 shows a flowchart of an embodiment of a process for training and validating a developed machine learning model. At early development stages of any machine learning measurement algorithms, obtaining large or comprehensive training sets to train and optimize a developed ML model is very difficult. In the embodiment of FIG. 2, the developer will design waveform parameters by selecting their value ranges and the step sizes between values within the range at 20. The developer then “sweeps” the waveform parameters, such as voltage levels and noise, relevant to the desired measurement outcomes. Sweeping the parameters involves stepping each parameter through each step within the range. Typically, one parameter at a time is swept through its range. The desired measurement outcomes will depend upon the nature of the test and DUT for which the ML model has been developed.

To generate a large number of waveforms, the developer will sweep waveform parameters relevant to the desired measurement outcomes, for each parameter. The waveform emulator will then use the swept parameter values at 22 to produce large data waveform sets. This results in large numbers of waveforms, usually in the thousands, at 24. The designed parameter sweep should also try to encapsulate as many possible scenarios as possible. For example, when generating training waveforms for an algorithm that predicts TDECQ values and waveforms, the emulated waveforms should include waveforms with a wide range of TDECQ values.

The developer can then use these large data sets to go through an iterative process of improving the ML model through a training-validation cycle until they reached a desired output ML model at 30. The training of the ML model at 26 will use some of the data sets to train the ML model to associate the parameters and the waveforms, such that when the ML model operates it associates the waveform with the parameters during run-time. This association generally leads to a prediction at 28. In the validation phase, the “answer” is known from the data sets, so the system tests the ML prediction against the predicted answer to check its accuracy. The accuracy may also have a confidence or accuracy level associated with it, such that if the ML model predictions are accurate some percentage of the time, the accuracy check passes and the developer has developed an accurate model at 30. If the accuracy check fails at 28, the model may require a redesign of the model and/or further training.

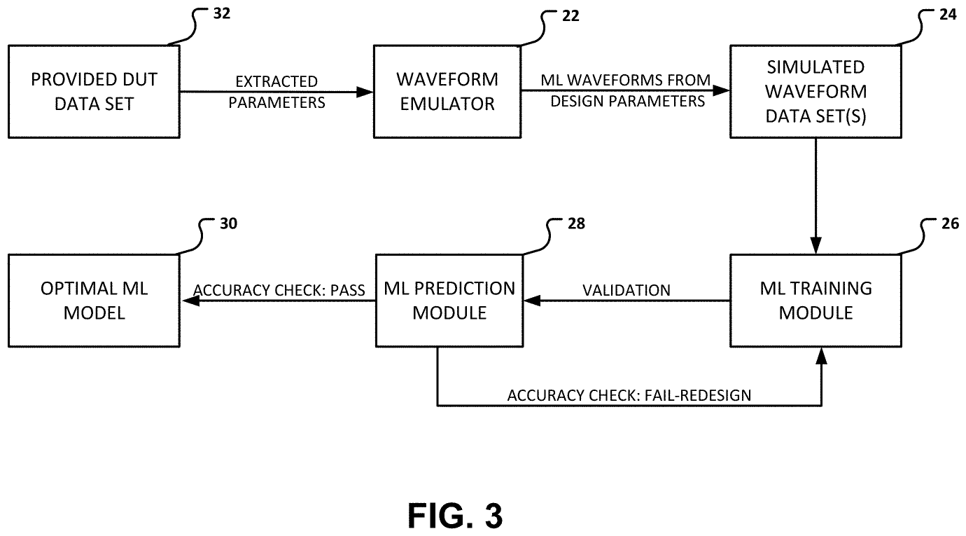

In some instances, the developer may have access to actual DUTs data, but typically only a small number of waveforms. FIG. 3 shows how the process can adjust to use actual DUT data. The provide DUT data set undergoes analysis, typically by the developer, but this analysis could be automated. This process measures and evaluates the actual DUTs data at 32 to extract necessary parameters for the waveform emulator. This will then guide the parameter sweep to design the sweep with ranges and step sizes of the sweep. The waveform emulator will then generate large number of training waveforms for machine learning algorithm development and training-validation cycles at 22. The rest of the process continues as in FIG. 2.

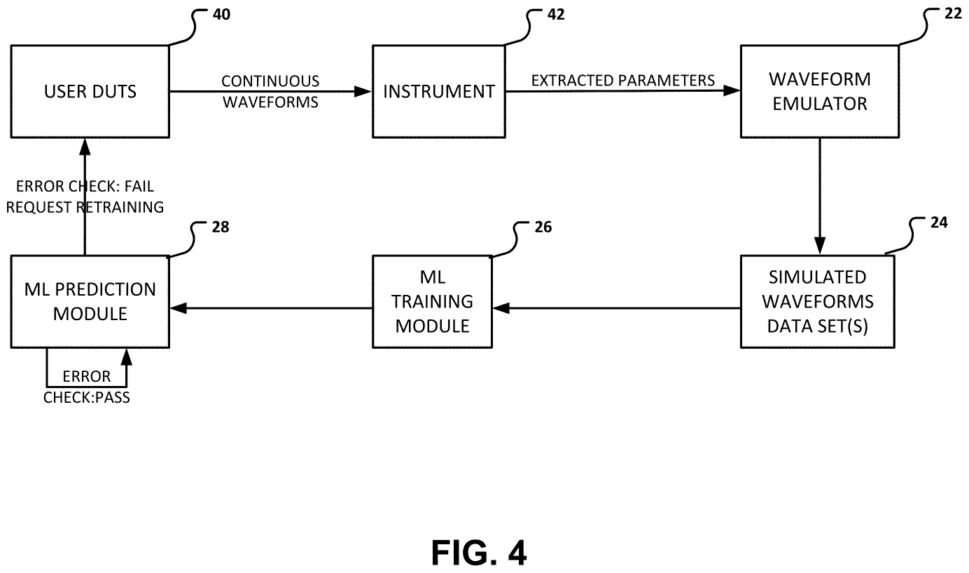

Once the process has provided the optimal ML model, it is deployed for use in a run-time environment. The waveform emulator could also operate in this environment to provide continuous checking and improvement of the ML model. FIG. 4 shows a closed loop retraining process for continuous improvement of the machine learning model.

The loop uses the DUT data like the embodiment of FIG. 3, using small number of DUTs data resulting from the user DUTs 40 and an instrument 42 to extract parameters to send to the waveform emulator 22. The process then continues to develop a trained model following the similar processes described above. Once the net deploys into the run-time environment, the workflow will periodically check the error metrics of the measurement at 28.

If the error check fails, it will automatically trigger a retraining of the model. In one embodiment, the retraining uses DUT data selected from the failed data sets and goes through the feature parameter extractions using a test and measurement instrument such as an oscilloscope at 42, waveform emulation at 22 to produce the training sets at 24, and training at 26 to come up with a new network. This process can theoretically continue indefinitely. The user can have high levels of flexibility through adjusting error tolerance in each iteration, the number of DUTs required as retraining inputs and limiting the maximum number of iterations allowed.

In this manner, developers have a useful process to automatically iterate through ML training and optimization. Customers will also gain the ability to do ‘hands free’ retraining to calibrate ML algorithms to their DUTs and equipment. Another advantage includes removing the need to acquire thousands of waveforms for development of ML models, saving large amounts of time and resources for both the developers and customers.

The ML models built from this process will be more comprehensive and generally more applicable due to greater control of the training data through the waveform emulator. It also allows for an automated continuous improvement process. Having segmented training and predictions modules provide for parallel development and improvement processes.

Aspects of the disclosure may operate on a particularly created hardware, on firmware, digital signal processors, or on a specially programmed general purpose computer including a processor operating according to programmed instructions. The terms controller or processor as used herein are intended to include microprocessors, microcomputers, Application Specific Integrated Circuits (ASICs), and dedicated hardware controllers. One or more aspects of the disclosure may be embodied in computer-usable data and computer-executable instructions, such as in one or more program modules, executed by one or more computers (including monitoring modules), or other devices. Generally, program modules include routines, programs, objects, components, data structures, etc. that perform particular tasks or implement particular abstract data types when executed by a processor in a computer or other device. The computer executable instructions may be stored on a non-transitory computer readable medium such as a hard disk, optical disk, removable storage media, solid state memory, Random Access Memory (RAM), etc. As will be appreciated by one of skill in the art, the functionality of the program modules may be combined or distributed as desired in various aspects. In addition, the functionality may be embodied in whole or in part in firmware or hardware equivalents such as integrated circuits, FPGA, and the like. Particular data structures may be used to more effectively implement one or more aspects of the disclosure, and such data structures are contemplated within the scope of computer executable instructions and computer-usable data described herein.

The disclosed aspects may be implemented, in some cases, in hardware, firmware, software, or any combination thereof. The disclosed aspects may also be implemented as instructions carried by or stored on one or more or non-transitory computer-readable media, which may be read and executed by one or more processors. Such instructions may be referred to as a computer program product. Computer-readable media, as discussed herein, means any media that can be accessed by a computing device. By way of example, and not limitation, computer-readable media may comprise computer storage media and communication media.

Computer storage media means any medium that can be used to store computer-readable information. By way of example, and not limitation, computer storage media may include RAM, ROM, Electrically Erasable Programmable Read-Only Memory (EEPROM), flash memory or other memory technology, Compact Disc Read Only Memory (CD-ROM), Digital Video Disc (DVD), or other optical disk storage, magnetic cassettes, magnetic tape, magnetic disk storage or other magnetic storage devices, and any other volatile or nonvolatile, removable or non-removable media implemented in any technology. Computer storage media excludes signals per se and transitory forms of signal transmission.

Communication media means any media that can be used for the communication of computer-readable information. By way of example, and not limitation, communication media may include coaxial cables, fiber-optic cables, air, or any other media suitable for the communication of electrical, optical, Radio Frequency (RF), infrared, acoustic or other types of signals.

Additionally, this written description makes reference to particular features. It is to be understood that the disclosure in this specification includes all possible combinations of those particular features. For example, where a particular feature is disclosed in the context of a particular aspect, that feature can also be used, to the extent possible, in the context of other aspects.

Also, when reference is made in this application to a method having two or more defined steps or operations, the defined steps or operations can be carried out in any order or simultaneously, unless the context excludes those possibilities.

Although specific aspects of the disclosure have been illustrated and described for purposes of illustration, it will be understood that various modifications may be made without departing from the spirit and scope of the disclosure. Accordingly, the disclosure should not be limited except as by the appended claims.

### Examples

Illustrative examples of the disclosed technologies are provided below. An embodiment of the technologies may include one or more, and any combination of, the examples described below.

Example 1 is a system to develop and test machine learning models, comprising: a waveform emulator machine learning system; a user interface to allow a user to input one or more design parameters for the waveform emulator machine learning system; one or more processors configured to execute code to cause the one or more processors to: send the one or more design parameters to the waveform emulator machine learning system; receive one or more data sets from the waveform emulator machine learning system, the one or more data sets based on the one or more design parameters; train a developed machine learning model using at least one of the one or more data sets, resulting in a trained machine learning model; validate the trained machine learning model using a previously unused one of the one or more data sets; adjust the trained machine learning model as needed; and repeat the training, validating, and adjusting until an optimal machine learning model is trained.

Example 2 is the system of Example 1, wherein the one or more design parameters comprises one or more design parameters determined from waveform parameters for one or more desired measurement outcomes.

Example 3 is the system of either of Examples 1 or 2, wherein the one or more design parameters comprises a sweep of values for each of the one or more design parameters.

Example 4 is the system of any of Examples 1 through 3, wherein one or more design parameters comprises one or more design parameters extracted from a data set derived from a set of devices under test.

Example 5 is the system of any of Examples 1 through 4, wherein the data set derived from the set of devices under test includes ranges of values and step sizes of parameter sweeps from the device under test data.

Example 6 is the system of any of Examples 1 through 5, wherein the one or more processors are further configured to: operate the optimal machine learning model in a run-time environment; and periodically check an error metric of the optimal machine learning model.

Example 7 is the system of Example 6, wherein the one or more processors are further configured to request retraining of the optimal machine learning model as needed when the error metric fails.

Example 8 is the system of Example 7, wherein the one or more processors are further configured to use device under test data from one or more data sets upon which the error metric failed for retraining or adjustment of the optimal machine learning model to develop a new machine learning model design.

Example 9 is the system of Example 6, wherein the one or more processors are further configured to continue to operate the optimal machine learning model in the run-time environment when the error metric passes.

Example 10 is a method of developing and testing machine learning models, comprising: providing one or more design parameters to a waveform emulator machine learning system; receiving one or more data sets from the waveform emulator machine learning system; training a developed machine learning model using at least one of the one or more data sets, resulting in a trained machine learning model; validating the trained machine learning model using a previously unused one of the one or more data sets; adjusting the trained machine learning model as needed; and repeating the training, validating, and adjusting until an optimal machine learning model is trained.

Example 11 is the method of Example 10, wherein providing one or more design parameters comprises providing one or more design parameters determined from waveform parameters for one or more desired measurement outcomes.

Example 12 is the method of either of Example 11, wherein the one or more desired measurement outcomes comprises a range of TDECQ values.

Example 13 is the method of any of Examples 10 through 12, wherein providing one or more design parameters comprises providing a sweep of values for each of the one or more design parameters.

Example 14 is the method of any of Examples 10 through 13, wherein providing one or more design parameters comprises receiving one or more design parameters extracted from a data set derived from a set of devices under test.

Example 15 is the method of Example 14, wherein the data set derived from the set of devices under test includes ranges of values and step sizes of parameter sweeps from the device under test data.

Example 16 is the method of any of Examples 10 through 15, further comprising: operating the optimal machine learning model in a run-time environment; and periodically checking an error metric of the optimal machine learning model.

Example 17 is the method of Example 16, further comprising requesting retraining of the optimal machine learning model as needed when the error metric fails.

Example 18 is the method of Example 17, further comprising using device under test data from one or more data sets upon which the error metric failed for the retraining or adjustment of the optimal machine learning model to redesign a new developed machine learning model.

Example 19 is the method of Example 16, further comprising continuing to operate the optimal machine learning model in the run-time environment when the error metric passes.

Example 20 is the method of any of Examples 10 through 19, wherein the developed machine learning model comprises a neural network.

The previously described versions of the disclosed subject matter have many advantages that either were described or would be apparent to a person of ordinary skill. Even so, these advantages or features are not required in all versions of the disclosed apparatus, systems, or methods.

Additionally, this written description makes reference to particular features. It is to be understood that the disclosure in this specification includes all possible combinations of those particular features. Where a particular feature is disclosed in the context of a particular aspect or example, that feature can also be used, to the extent possible, in the context of other aspects and examples.

Also, when reference is made in this application to a method having two or more defined steps or operations, the defined steps or operations can be carried out in any order or simultaneously, unless the context excludes those possibilities.

Although specific examples of the invention have been illustrated and described for purposes of illustration, it will be understood that various modifications may be made without departing from the spirit and scope of the invention. Accordingly, the invention should not be limited except as by the appended claims.

We claim:

1. A system to develop and test machine learning models, comprising:
a waveform emulator machine learning system;
a user interface to allow a user to input one or more design parameters for the waveform emulator machine learning system;
one or more processors configured to execute code to cause the one or more processors to:
send the one or more design parameters to the waveform emulator machine learning system;
receive one or more data sets from the waveform emulator machine learning system, the one or more data sets based on the one or more design parameters;
train a developed machine learning model using at least one of the one or more data sets, resulting in a trained machine learning model;
validate the trained machine learning model using a previously unused one of the one or more data sets;
adjust the trained machine learning model as needed; and
repeat the training, validating, and adjusting until an optimal machine learning model is trained.

2. The system as claimed in claim 1, wherein the one or more design parameters comprises one or more design parameters determined from waveform parameters for one or more desired measurement outcomes.

3. The system as claimed in claim 1, wherein the one or more design parameters comprises a sweep of values for each of the one or more design parameters.

4. The system as claimed in claim 1, wherein one or more design parameters comprises one or more design parameters extracted from a data set derived from a set of devices under test.

5. The system as claimed in claim 4, wherein the data set derived from the set of devices under test includes ranges of values and step sizes of parameter sweeps from the device under test data.

6. The system as claimed in claim 1, wherein the one or more processors are further configured to:
operate the optimal machine learning model in a run-time environment; and
periodically check an error metric of the optimal machine learning model.

7. The system as claimed in claim 6, wherein the one or more processors are further configured to request retraining of the optimal machine learning model as needed when the error metric fails.

8. The system as claimed in claim 7, wherein the one or more processors are further configured to use device under test data from one or more data sets upon which the error metric failed for retraining or adjustment of the optimal machine learning model to develop a new machine learning model design.

9. The system as claimed in claim 6, wherein the one or more processors are further configured to continue to operate the optimal machine learning model in the run-time environment when the error metric passes.

10. A method of developing and testing machine learning models, comprising:
providing one or more design parameters to a waveform emulator machine learning system;
receiving one or more data sets from the waveform emulator machine learning system;
training a developed machine learning model using at least one of the one or more data sets, resulting in a trained machine learning model;
validating the trained machine learning model using a previously unused one of the one or more data sets;
adjusting the trained machine learning model as needed; and
repeating the training, validating, and adjusting until an optimal machine learning model is trained.

11. The method as claimed in claim 10, wherein providing one or more design parameters comprises providing one or more design parameters determined from waveform parameters for one or more desired measurement outcomes.

12. The method as claimed in claim 11, wherein the one or more desired measurement outcomes comprises a range of TDECQ values.

13. The method as claimed in claim 10, wherein providing one or more design parameters comprises providing a sweep of values for each of the one or more design parameters.

14. The method as claimed in claim 10, wherein providing one or more design parameters comprises receiving one or more design parameters extracted from a data set derived from a set of devices under test.

15. The method as claimed in claim 14, wherein the data set derived from the set of devices under test includes ranges of values and step sizes of parameter sweeps from the device under test data.

16. The method as claimed in claim 10, further comprising:
operating the optimal machine learning model in a run-time environment; and
periodically checking an error metric of the optimal machine learning model.

17. The method as claimed in claim 16, further comprising requesting retraining of the optimal machine learning model as needed when the error metric fails.

18. The method as claimed in claim 17, further comprising using device under test data from one or more data sets upon which the error metric failed for the retraining or adjustment of the optimal machine learning model to redesign a new developed machine learning model.

19. The method as claimed in claim 16, further comprising continuing to operate the optimal machine learning model in the run-time environment when the error metric passes.

20. The method as claimed in claim 10, wherein the developed machine learning model comprises a neural network.
